(19) United States
(12) Patent Application Publication
(10) Pub. No.: US 2008/0198908 A1
(43) Pub. Date: Aug. 21, 2008

(54) Transceiver

(75) Inventor: Martin Wagner, Norderstedt (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/916,678

(22) PCT Filed: Jun. 6, 2006
(86) PCT No.: PCT/IB06/51793

§ 371 Date: Dec. 6, 2007

(30) Foreign Application Priority Data
Jun. 9, 2005 (EP) 05105070.6

(51) Int. Cl. G06F 13/40

(52) U.S. Cl. 375/219

(57) ABSTRACT

To provide a transceiver (100) comprising a transmitter (10) and a receiver (13) for transmitting and receiving signals via a bus system (11), and a transmitter control unit (12), which transceiver ensures minimal electromagnetic emission, it is proposed that a monitoring circuit (14) for monitoring the transmitted signals is assigned to the transceiver (100), which circuit provides the possibility of a stepwise adaptation of the signal edge to the desired signal shape.

The invention relates to a transceiver comprising a transmitter and a receiver for transmitting and receiving signals via a bus system, and a transmitter control unit.

In practice, various embodiments of transceivers are known and familiar to those skilled in the art. A transceiver is used for transmitting and receiving signals or information via a bus system. The bus system may be either formed with electric wires or it may be wireless. A transmitter, which can be formed arbitrarily, and supplies, for example, signals to an electric wire, is used for transmitting signals. These signals can be received by a further transceiver, viz. its receiver, possibly processed and/or passed on.

In the field of, for example, the motor vehicle technique, it is necessary that the transceiver transmits signals in such a way that, due to the signal transmission via the bus system, transmitted electromagnetic waves do not influence or disturb other systems in the motor vehicle, for example, a radio or GPS receiver. Similarly, further transceivers or bus systems may not be influenced. To this end, emissions of the transceiver should be minimized. It is also necessary that the transceiver is immune to external electromagnetic disturbances by, for example, other components in the motor vehicle.

It is known that signals are symmetrically transmitted via both wires of the bus in two-wire bus systems, so that the electromagnetic fields emanating from these wires superimpose and cancel each other. Furthermore, it is possible that edges of the signals formed, for example, as sine waves or as step-shaped edges, are influenced in such a way that disturbing emissions only occur in a minimal electromagnetic frequency range and that substantially no emissions of the bus system or the transceiver are generated outside this frequency range.

However, this has the drawback that the generated emissions in such systems are strongly dependent on manufacturing tolerances for the transceiver and on the actual implementation of the bus system. Any asymmetry in the bus system increases its emissions which cannot be substantially compensated by the transceiver.

To this end, it is known to provide a feedback loop with which the transmitted signals are monitored and, if necessary, the shape of the signal edges is changed so as to obtain a better symmetry of the transmitted signals. However, if the bus system is influenced by an external electromagnetic field, this will also lead to a feedback and, consequently, to an unwanted change of the transmitted signals, so that the exchange of data via the bus system may be impeded.

U.S. Pat. No. 6,484,223 describes a transmitter and a bus system for data exchange. Signals formed as sine-shaped half-waves are transmitted. A change of the shape of the signals in dependence upon external influences is not possible in this system.

U.S. Pat. No. 5,732,106 describes an arrangement for generating signal edges in the form of sine half-waves generated by means of D/A conversion.

US 2004/0135646 A1 describes the adaptation of a data transmission network to a characteristic impedance of the bus system, in which interferences occurring in the bus system can be filtered out.

US 2003/0163748 A1 describes the reduction of electromagnetic emissions by clocking in the transmission of signals via a bus system so as to spectrally distribute the electromagnetic waves over a wider frequency range. A change of the signal shape is not provided.

JP 9-298563 describes a circuit for binary data transmission.

It is an object of the invention to provide a transceiver having considerably reduced emissions and being insensitive to external electromagnetic influences.

This object is achieved by the characteristic features defined in claim 1.

The basic idea of the invention is that a monitoring circuit for monitoring the transmitted signals is assigned to the transceiver or to the transmitter which transmits the actual signals. It will be evident that this monitoring circuit is integrated in the transceiver which is preferably formed as an integrated circuit. To this end, one or more edges of a signal transmitted via the bus system are monitored and evaluated by the monitoring circuit on whether the transmitted signal is within preferably adjustable tolerance limits. If this monitoring were to lead to the conclusion that the transmitted signal deviates too much from a predefined shape, the transmitter control unit in the transceiver can be controlled by the monitoring circuit in such a way that a slightly changed signal is transmitted by the transmitter, so that it is within the tolerances again. The transmitter control unit is then preferably controlled in such a way that a parameter influencing the shape of the signal transmitted by the transmitter is either slightly increased or decreased so as to compensate a determined deviation. Only the tendency, i.e. whether a parameter is increased or decreased, and the subsequent change of this parameter are important in this respect. This may be realized, for example, in a plurality of consecutive steps, in which the monitoring circuit monitors whether the intended changes of the parameter lead to a situation in which the shape of the transmitted signal again approaches the desired or predetermined value. A possible parameter may be the edge steepness.

It will be evident that such a parameter is not changed when a transmission process is in progress, but only in intervals between these processes so as to avoid a change of the signal during transmission, as this could lead to erroneous interpretations in a receiver. Since the transmitter customarily transmits at a high frequency, adaptation to changed conditions, which are caused, inter alia, by an external disturbance, is realized relatively rapidly within a few seconds, because the monitoring circuit may slightly change a parameter after each transmission process.

A transceiver according to the invention has the advantage that it independently adapts its transmitter stage to the actual physical situation of a closed bus system and thus provides a minimal low-emission transmission of data. Greater sensitivity to external disturbances on the bus is avoided.

Advantageous embodiments of the invention are defined in the dependent claims.

The monitoring circuit as defined by the characteristic features of claim 2 can monitor a plurality of parameters each having their own influence on the edge shape of the signal transmitted by the transmitter. These parameters can be slightly increased or decreased either independently or jointly by the monitoring circuit or the transmitter control unit at the next transmission process, so as to again obtain an edge shape of the signal within the tolerances.

As defined in claim 3, the parameters are changed stepwise so as to determine that, for example, a stepwise increase of a parameter leads to the desired result. If this is not the case, the parameter will be stepwise decreased in subsequent transmission processes. Those skilled in the art can choose the step size in dependence upon the relevant parameter. However, in principle, it is also possible to change the parameters continuously.

Such a transceiver as defined in claim 4 is preferably used with a one-wire or a two-wire bus system, which is known to those skilled in the art. In this system, signals are transmitted or received via one or two electric lines, respectively.

As defined in claim 5, the monitoring circuit, particularly in two-wire bus systems, can influence the symmetry of a signal transmitted by the transmitter so as to obtain a possibly symmetrical signal via both electric lines, so that substantially no electromagnetic emissions occur. To this end, the corresponding parameters can also be changed stepwise so as to obtain a symmetrical signal again after the monitoring circuit has detected an asymmetry caused, for example, by external influences.

If the monitoring circuit consecutively finds an undeterminable, incorrect result in a plurality of signals or measuring processes, this may be evaluated as the presence of a considerable external disturbance, which, under circumstances, cannot be compensated by adapting the signal or the edge shape. In this case, the transceiver as defined in claim 6 can supply a warning signal so as to notify a user about the presence of this external disturbance. The warning signal can also be applied to a host system of the transceiver. In this case, the output signals are formed by the monitoring circuit or the transmitter control unit, such that, despite the external disturbance, they can be reliably received by other transceivers connected to the bus system. To this end, the signal edges are preferably adjusted to be very steep. It is true that this leads to increased emissions, but it ensures a secure signal transmission in the bus system.

Dependent on the parameter that is changed by the monitoring circuit or the transmitter control unit, it may be necessary to perform a different number of consecutive measurements or monitoring operations so as to reliably determine whether the desired result has been achieved. Accordingly, the number of measurements performed until a parameter is changed depends on the parameter to be monitored, as is defined in claim 7.

When the monitoring circuit detects a correct signal transmission or a desired signal shape in a plurality of consecutive measurements, a counter, which is preferably integrated in the transceiver, can be incremented, i.e. increased by a count of one, as defined in claim 8. When a measurement has yielded an incorrect result, the count is decremented by one. The number of measurements as from which a change of a transmitter parameter becomes necessary is thus dependent on the count, because the parameter is not changed until the count is zero.

As defined in claim 9, the monitoring circuit can be deactivated, which may be effected particularly via a host system of the transceiver, in which the parameters for signal transmission by the transmitter subsequently assume fixed values either stepwise or directly, which values ensure a reliable operation under normal conditions, i.e. without external influences. Such parameter values may also be adopted with which, as described hereinbefore, a reliable operation or a secure transmission of information is ensured despite the presence of a large external disturbance. In this case, for example, the host system may predetermine which mode of operation is to be performed subsequently.

These and other aspects of the invention are apparent from and will be elucidated with reference to the embodiments described hereinafter.

In the drawing:

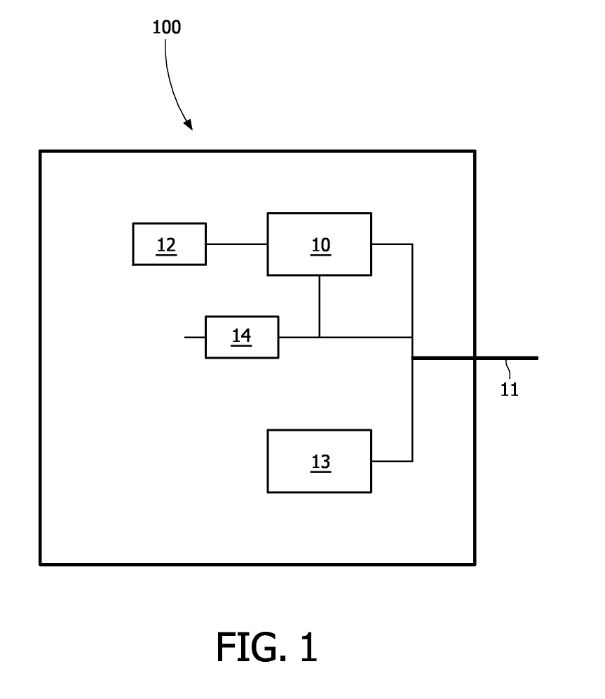

FIG. 1 is a block diagram of a transceiver.

The basic structure of a transceiver 100 is shown in the block diagram in FIG. 1. A transceiver 100 essentially comprises a transmitter 10 for transmitting signals via a bus system 11 to, for example, a similar transceiver 100, which is also connected to the bus system 11, and a receiver 13 for receiving signals. The bus system 11, for example, a one-wire or two-wire bus system is shown only diagrammatically in the Figure. The transceiver 100 is preferably formed as an integrated circuit.

The transmitter 10 is controlled by a transmitter control unit 12 which in the desirable way can change, for example, the shape of the signals transmitted by the transmitter 10 via the bus system 11. A parameter for changing a signal shape may be, for example, the edge steepness or a wavelength.

The transceiver 100 additionally comprises a monitoring circuit 14 which is also connected to the bus system 11 so as to monitor the shape of the signals supplied to the bus system 11 by the transmitter 10. Particularly, the signals generated by the transmitter 10 may be compared with the signals actually occurring at the bus system 11 so that deviations can be detected. When the monitoring circuit 14 detects a deviation of a transmitted signal from a desired signal shape, the monitoring circuit 14 controls the transmitter control unit 12 in such a way that one or more parameters influencing the shape of the signal transmitted by the transmitter 10 are increased or decreased preferably stepwise so as to obtain the desired signal shape again.

Furthermore, the monitoring circuit 14 may also be deactivated, for example, by a host system of the transceiver 100, and the transceiver 100 may be subsequently controlled in such a way that the signals are transmitted reliably, despite the presence of a large external disturbance. To this end, particularly the edge steepness of the transmitted signals can be increased.

### LIST OF REFERENCE NUMERALS

100 transceiver
10 transmitter
11 bus system
12 transmitter control unit
13 receiver
14 monitoring circuit

1. A transceiver comprising a transmitter and a receiver for transmitting and receiving signals via a bus system, and a transmitter control unit, characterized in that a monitoring circuit for monitoring the transmitted signals is assigned to the transceiver

2. A transceiver as claimed in claim 1, characterized in that a plurality of signal parameters can be monitored.

3. A transceiver as claimed in claim 1, characterized in that the parameters can be changed stepwise.

4. A transceiver as claimed in claim 1, characterized in that the bus system is a one-wire or a two-wire bus system.

5. A transceiver claimed in claim 1, characterized in that the monitoring circuit can influence a symmetry of a transmitted signal.

6. A transceiver claimed in claim 1, characterized in that a warning signal can be supplied when an external disturbance is detected and that, additionally, the signal edge may be stepwise adapted in such a way that secure data transmission will become possible.

7. A transceiver as claimed in claim 1, characterized in that a plurality of measurements leading to a change of a parameter is adjustable in dependence upon the parameter.

8. A transceiver as claimed in claim 1, characterized in that a counter is assigned to the transceiver, which counter is incrementable in the case of a correct measurement and decrementable in the case of an incorrect measurement, and in which a parameter is changed only when the count is zero.

9. A transceiver as claimed in claim 1, characterized in that a monitoring circuit can be deactivated, particularly via a host system, and that the transceiver can be subsequently operated with fixed parameters.
